(19) United States
(12) Patent Application Publication
(10) Pub. No.: US 2017/0058810 A1
(43) Pub. Date: Mar. 2, 2017

(54) CONTROL WITH EMITTER FOR SMALL ENGINE APPLICATIONS

(71) Applicant: WALBRO ENGINE MANAGEMENT, L.L.C., Tucson, AZ (US)

(72) Inventors: Martin N. Andersson, Caro, MI (US); Cyrus M. Healy, Ubly, MI (US); Jason L. Osantowski, Cass City, MI (US)

(73) Assignee: Walbro Engine Management, L.L.C., Tucson, AZ (US)

(21) Appl. No.: 15/308,460

(22) PCT Filed: May 21, 2015
(86) PCT No.: PCT/US2015/031992

§ 371 Date: Nov. 2, 2016

Related U.S. Application Data
(60) Provisional application No. 62/002,306, filed on May 23, 2014.
(60) Provisional application No. 62/145,737, filed on Apr. 10, 2015.

(51) Int. Cl. F02D 41/22; F02P 1/08; G08B 5/36; F02P 5/15

(52) U.S. Cl. CPC F02D 41/22; F02P 5/1502; F02P 1/086; G08B 5/36; F02D 2041/228; F02D 2400/06

(57) ABSTRACT

A control system for a small engine operated device includes an emitter carried by the engine or a portion of the device spaced from the engine and a control circuit. The control circuit may include memory with which control data related to device conditions, engine conditions or both is stored, and a processor in electrical communication with the first emitter. The control circuit provides a signal corresponding to the control data to the emitter so that the emitter provides an output in response to device conditions, engine conditions, or both.

### REFERENCE TO CO-PENDING APPLICATIONS

This application claims the benefit of U.S. Provisional Application Nos. 62/002,306 filed May 23, 2014 and 62/145,737 filed Apr. 10, 2015, which are incorporated herein by reference in their entirety.

### TECHNICAL FIELD

The present disclosure relates generally to internal combustion engines, and more particularly, to small engine control systems.

### BACKGROUND

Small internal combustion engines are used in a variety of applications, such as various tools like chainsaws, leaf blowers, lawn mowers, trimmers, edgers and the like. Some light duty engines are single cylinder two-stroke or four-stroke gasoline powered internal combustion engines. These engines typically do not have a separate battery for supplying an electric current to the spark plug and instead utilize flywheel mounted magnets to generate power for a capacitive discharge ignition system. These engines are manually cranked for starting with an automatic recoil rope starter.

### SUMMARY

A control system for a small engine operated device includes an emitter carried by the engine or a portion of the device spaced from the engine and a control circuit. The control circuit may include memory with which control data related to device conditions, engine conditions or both is stored, and a processor in electrical communication with the first emitter. The control circuit provides a signal corresponding to the control data to the emitter so that the emitter provides an output in response to device conditions, engine conditions, or both.

In at least some implementations, the first emitter provides at least one of an audible, tactile, or visible output recognizable to a user, and the first emitter may be a light-emitting diode (LED). The device may include a switch having at least two states, the emitter may be associated with the switch, and the memory may include an application executable by the processor. The application may include the steps of receiving an indication of an engine condition or a device condition, and providing a predetermined electrical signal to the first emitter that corresponds to the indication while the switch is in at least one of said states.

In at least some implementations, the control system may also include an illumination member illuminated by a second emitter. The second emitter may be electrically coupled to the first emitter, and the processor may also provide a signal corresponding to control data to the second emitter in response to device conditions, engine conditions, or both received by the processor.

In at least some implementations, a control system for a small engine and small-engine device includes a kill switch terminal having a first emitter and a switch element, the switch element being configured for manual operation between at least two positions, and a control circuit. The control circuit may include memory that includes a non-transitory computer readable medium and a processor in electrical communication with the first emitter. The memory includes an application executable by the processor to provide a signal corresponding to control data to the first emitter in response to device conditions, engine conditions, or both received by the processor.

In at least some implementations, the first emitter may provide at least one of an audible, tactile, or visible output recognizable to a user. And in at least some implementations the first emitter is a light-emitting diode (LED). The application may include the steps of receiving an indication of an engine condition or a device condition and providing a predetermined electrical signal to the first emitter that corresponds to the indication while the switch is in at least one of its positions. The control system may also include an illumination member illuminated by a second emitter, and the second emitter may be electrically coupled to the first emitter, and the processor may also provide a signal corresponding to control data to the second emitter in response to device conditions, engine conditions, or both received by the processor.

A method of providing control data to an operator of a small engine device is also described. The method, in at least some implementations, includes the steps of:

powering a processor during small engine operation;

receiving an indication of an engine condition or a device condition at the processor; and

communicating to at least one emitter a control signal corresponding to the received indication.

In at least some implementations, the control signal includes a predetermined pattern associated with a control message. The emitter may provide a visual indication corresponding to the received indication, and the visual indication may include emitted light.

### BRIEF DESCRIPTION OF THE DRAWINGS

The following detailed description of preferred embodiments and best mode will be set forth with reference to the accompanying drawings, in which:

FIGS. 1A and 1B are perspective views of a device embodiment having a kill switch terminal;

FIG. 2 is a schematic diagram illustrating a capacitor discharge ignition (CDI) system, a control circuit, and the kill switch terminal, the CDI system generally having a stator assembly mounted adjacent to a rotating flywheel;

FIG. 3 is an electrical schematic diagram of an embodiment of the control circuit and kill switch terminal shown in FIG. 2;

FIG. 4 is a flowchart of an embodiment of a method of providing control codes using the control circuit and kill switch terminal of FIG. 2;

FIGS. 5A, 5B, and 5C are illustrative diagrams of predetermined electrical signals corresponding to control codes; and

FIG. 6 is a perspective view of an embodiment that includes an instrument cluster panel.

### DETAILED DESCRIPTION

The methods and systems described herein generally relate to a control system for a light-duty, gasoline powered, spark plug ignited internal combustion engine and a tool including such an engine. The control system may include processor or controller circuitry electronically coupled to an engine stop or kill switch terminal, as well as other components. In at least some implementations, the processor circuitry can be used to provide control data to a user or operator of the engine via an audible, tactile, or visible emitter on the kill switch terminal. In addition, the switch terminal may be manually actuated by the operator to stop or terminate operation of the running engine, and often may be mounted on a cowl, cover, or housing of the engine accessible from the exterior of the engine housing.

Typically the light duty engine is a single cylinder two-stroke or four-stroke gasoline powered internal combustion engine. A single piston is slidably received for reciprocation in the cylinder and connected by a tie rod to a crank shaft attached to a fly wheel and typically having a capacitive discharge ignition “CDI” system for supplying a high voltage ignition pulse to a spark plug for igniting an air-fuel mixture in the engine combustion chamber. These engines do not have a separate battery for supplying an electric current to the spark plug and powering the ignition control circuitry that includes a microprocessor. Typically these engines are manually cranked for starting with an automatic recoil rope starter.

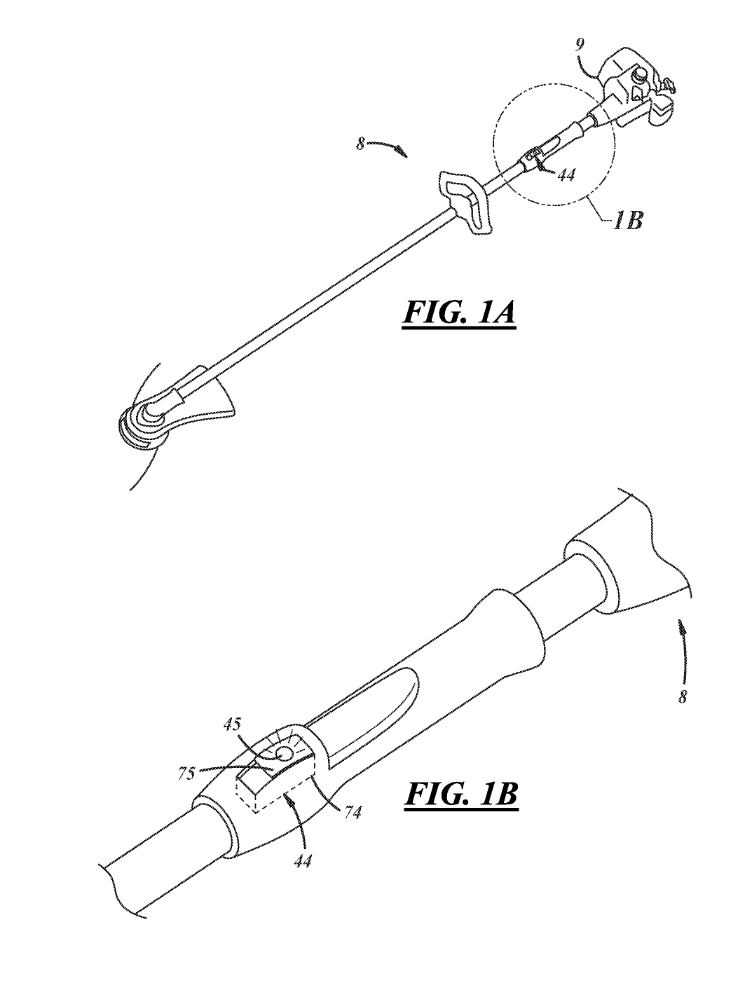

The term “light-duty combustion engine” broadly includes all types of non-automotive combustion engines, including two- and four-stroke engines typically used to power various devices 8 (FIG. 1A), such as internal-combustion, gasoline-powered, hand-held power tools, lawn and garden equipment, lawnmowers, weed trimmers, edgers, chain saws, snowblowers, personal watercraft, boats, snowmobiles, motorcycles, all-terrain-vehicles, etc. The control system and method(s) can record device data, engine data, or both. This device and/or engine data can be obtained using firmware stored on a microcontroller that also controls the device and engine systems; thereafter, this data may be associated with one or more control codes (e.g., diagnostic codes) that then can be communicated to the operator via the emitter on the kill switch terminal.

Device data includes any data pertinent or relevant to components or sub-systems of the device or characteristics thereof. As shown in FIG. 1A for example, the illustrated device 8 is a weed trimmer. Example device data for a weed trimmer may include data pertaining to whether trimmer line needs to be advanced from a spool at the device's distal end. Other non-limiting examples of device data include: data pertaining to the amount of fuel remaining in a fuel tank (e.g., in a lawn mower), time to sharpen chain in chain saw, time to change oil in four-stroke engine, just to name a few of examples. Engine data may pertain to any data pertinent or relevant to components or sub-systems of the device's engine 9 or characteristics thereof. For example, engine data may include an indication that an engine air filter needs replacement or cleaning (e.g., lawn mowers, trimmers, chainsaws, etc.). Other non-limiting examples of engine data include: data pertaining to the ratio of fuel-to-air mixture in the engine's carburetor (e.g., lawn mowers, trimmers, chainsaws, etc.), engine running at a temperature that is too hot, just to name a couple of examples. The terms device data and engine data should be broadly construed to include any data relevant to the operation, controls (including diagnostics or other feedback), and/or maintenance of the device 8 and its engine 9.

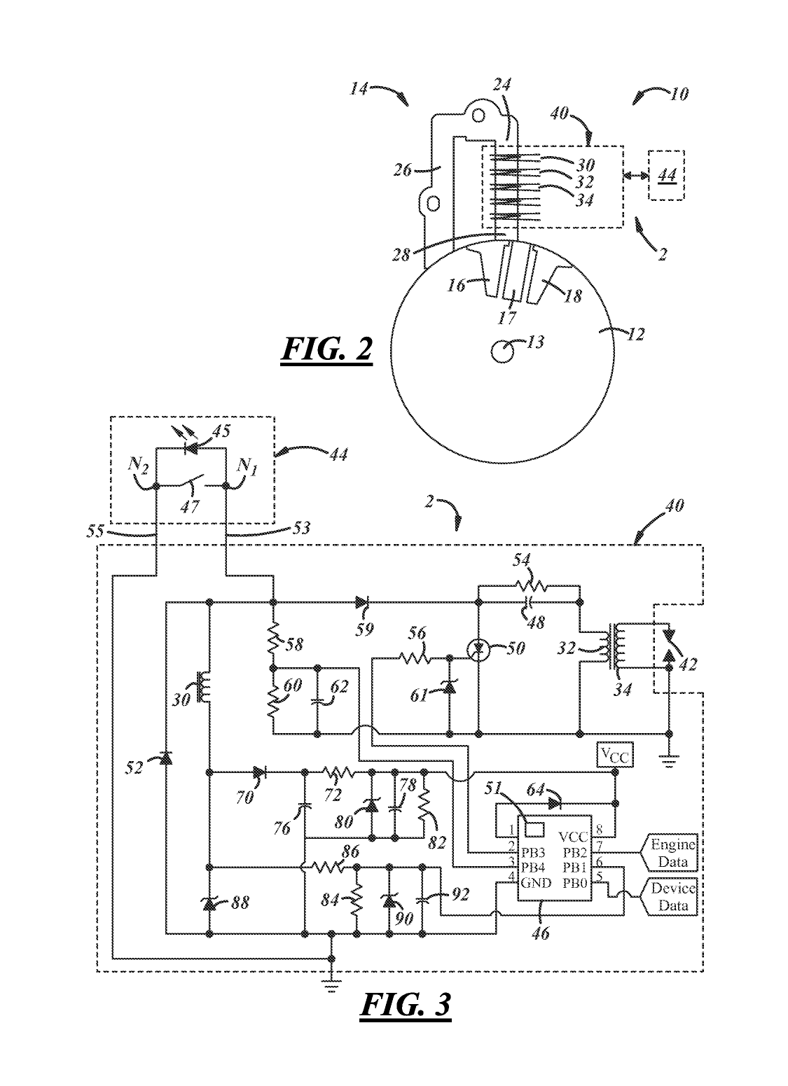

As will be explained in greater detail, light-duty engines can use a capacitive discharge ignition (CDI) system 10—an example of which is shown in FIG. 2—that includes one of a number of control circuits, including the exemplary embodiment described in relation to FIG. 3. The CDI system 10 generally includes a flywheel 12 rotatably mounted on an engine crankshaft 13, a stator assembly 14 mounted adjacent the flywheel, and a control circuit 40. Flywheel 12 rotates with the engine crankshaft 13 and generally includes a permanent magnetic element having pole shoes 16, 18, and a permanent magnet 17, such that it induces a magnetic flux in the nearby stator assembly 14 as the magnets pass thereby.

Stator assembly 14 may be separated from the rotating flywheel 12 by a measured air gap (e.g. the air gap may be 0.3 mm), and may include a lamination stack 24 having first and second legs 26, 28, a charge coil winding 30 and an ignition coil comprising a primary winding 32 and a secondary ignition winding 34. The lamination stack 24 may be a generally U-shaped ferrous armature made from a stack of iron plates, and may be mounted to a housing (not shown) located on the engine. Preferably, the charge winding 30 and primary and secondary ignition windings 32, 34 are all wrapped around a single leg of the lamination stack 24. Such an arrangement may result in a cost savings due to the use of a common ground and a single spool or bobbin for all of the windings. The ignition coil may be a step-up transformer having both the primary and secondary ignition windings 32, 34 wound around the second leg 28 of the lamination stack 24. Primary ignition winding 32 is coupled to the control circuit 40, as will be explained, and the secondary ignition winding 34 is coupled to a spark plug 42 (shown in FIG. 3) of the engine. As is appreciated by those skilled in the art, primary ignition winding 32 may have comparatively few turns of relatively heavy wire, while secondary ignition winding 34 may have many turns of relatively fine wire. The ratio of turns between the primary and secondary ignition windings 32, 34 generates a high voltage potential in the secondary winding 34 that is used to fire spark plug 42 or provide an electric arc and consequently ignite an air/fuel mixture in the engine combustion chamber.

The control circuit 40 is coupled to stator assembly 14 and spark plug 42 and generally controls the energy that is induced, stored and discharged by the CDI system 10. The term “coupled” broadly encompasses all ways in which two or more electrical components, devices, circuits, etc. can be in electrical communication with one another; this includes but is certainly not limited to, a direct electrical connection and a connection via an intermediate component, device, circuit, etc. The control circuit can be provided according to one of a number of embodiments, including the exemplary embodiment shown in FIG. 3.

Referring now to FIG. 3, a control system 2 is shown that includes the kill switch terminal 40 and also utilizes elements of the CDI system 10; more specifically elements of the control circuit 40. Circuit 40 is an example of the type of control circuit that may be used to implement the ignition timing systems described herein. However, many variations of this circuit may alternatively be used. Circuit 40 interacts with charge winding 30, primary ignition winding 32, and a kill switch terminal 44, and generally comprises a microcontroller 46, an ignition discharge capacitor 48, and an ignition switch 50. The majority of the energy induced in charge winding 30 is dumped onto ignition discharge capacitor 48, which stores the induced energy until the microcontroller 46 permits it to discharge. According to an embodiment shown here, a positive terminal of charge coil 30 is coupled to a diode 52 and a diode 59, which in turn is coupled to ignition discharge capacitor 48. A resistor 54 may be coupled in parallel to the charge ignition discharge capacitor 48.

During operation, rotation of flywheel 12 causes the magnetic elements, such as pole shoes 16, 18, to induce voltages in various coils arranged around the lamination stack 24. One of those coils is charge winding 30, which charges ignition discharge capacitor 48 through diode 59. A trigger signal from the microcontroller 46 activates switch 50 so that the ignition discharge capacitor 48 can discharge and thereby create a corresponding ignition pulse in the ignition coil. In one example, the ignition switch 50 can be a thyristor, such as a silicon controller rectifier (SCR). When the ignition switch 50 is turned ‘on’ (in this case, becomes conductive), the switch 50 provides a discharge path for the energy stored on ignition discharge capacitor 48. This rapid discharge of the ignition discharge capacitor 48 causes a surge in current through the primary ignition winding 32 of the ignition coil, which in turn creates a fast-rising electro-magnetic field in the ignition coil. The fast-rising electro-magnetic field induces a high voltage ignition pulse in secondary ignition winding 34. The high-voltage ignition pulse travels to spark plug 42 which, assuming it has the requisite voltage, provides a combustion-initiating spark. Other sparking techniques, including flyback techniques, may be used instead.

The microcontroller 46, as shown in FIG. 3, can store code for the ignition timing systems described herein. In addition, the microcontroller 46 can also store data for implementing the system and method described herein and/or storing the device and/or engine data obtained by the method. Stored data should be broadly construed to include look-up data, control code data (e.g., including diagnostic trouble codes or diagnostic status indicators), application data (which may include software applications, firmware applications, etc.). Various microcontrollers or microprocessors may be used, as is known to those skilled in the art. Examples of how microcontrollers can be implemented with ignition timing systems can be found in U.S. Pat. No. 7,546,836 and U.S. Pat. No. 7,448,358 which are incorporated by reference.

For instance, the microcontroller 46 may include memory 51, e.g., a reprogrammable or flash EEPROM (electrically erasable, programmable read-only memory). In other instances, memory 51 may be external of and coupled to microcontroller 46. Regardless, memory 51 should be construed broadly to include other types of memory such as RAM (random access memory), ROM (read-only memory), EPROM (erasable, programmable ROM), or any other suitable non-transitory computer readable medium.

The microcontroller 46 shown in FIG. 3 includes 8 pins. Pin 8 of the microcontroller 46 can be coupled to a voltage source (V_{CC}) which supplies the microcontroller 46 with power. The circuit 40 depicts capacitors 76 and 78, a zener diode 80, and resistors 72 and 82 electrically connected in circuit to pin 8 as well. In this example, pin 1 is a reset pin that is coupled to the voltage source (V_{CC}) and pin 8 via a diode 64. Pin 2 is coupled to the gate of ignition switch 50 via resistor 56, which is wired in circuit with zener diode 61, and transmits from the microcontroller 46 an ignition signal which controls the state of the switch 50. When the ignition signal on pin 2 is low, the ignition switch 50 is nonconductive and capacitor 48 is allowed to charge. When the ignition signal is high, the ignition switch 50 is conductive and ignition discharge capacitor 48 discharges through primary ignition winding 32, thus causing a high-voltage ignition pulse to be induced in secondary ignition winding 34 and sent to the spark plug 42. Thus, the microcontroller 46 can govern the discharge of capacitor 48 by controlling the conductive state of the switch 50.

Pin 6 is coupled to the charge winding 30 via resistors 84 and 86, zener diodes 88 and 90, and capacitor 92; in addition, a diode 70 controls current from the output of a diode 88 and previously discussed resistor 72. Pin 6 receives an electronic signal representative of the position of an engine piston in its combustion chamber usually relative to the top dead center (TDC) location of the piston. This signal can be referred to as a timing signal. The microcontroller 46 can use the timing signal to determine engine speed, the timing of an ignition pulse relative to the piston(s), TDC position (usually from a look-up table), and whether or not and, if so, when to activate an ignition pulse. The piston position signal can also be referred to as a positive pulse. Pin 3 handles data communication input/output and kill sensing. It is coupled to the kill switch terminal 44 via resistors 58 and 60 and, capacitor 62. And pins 5 and/or 7 may be used to receive engine and/or device data.

Kill switch terminal 44 acts as a manual override for shutting down the engine. The kill switch terminal 44 can include a power/data coupling or connection 53 that electrically communicates with the microcontroller 46 (pin 3) and is accessible for receiving data from the microcontroller 46. The term “electrically communicates” can mean the communication of power and/or data in the form of electrical signals (e.g. voltage or current). As used herein, the kill switch terminal 44 may be used to collectively refer to a number of elements. For example, the kill switch terminal may include an emitter 45 and a circuit element 47 arranged in parallel connection via nodes N₁, N₂ such that both are electrically coupled to the power/data connection 53 at node N₁ and to a ground coupling or connection 55 at node N₂. In FIG. 3, the emitter 45 is a light element such as a light-emitting diode (LED) and the switch element 47 is a two-position switch—more specifically, a single-pole single-throw (SPST) device; however, these are merely examples—other audible, tactile, or visible emitter implementations and switch types exist. The illustrated switch element may have a RUN engine position and a STOP engine position; here, the RUN engine position is the switch element 47 in an ‘open’ position (as shown in FIG. 3) and the STOP engine position is the switch element 47 in a ‘closed’ position. However, this is merely an example; other configurations are possible.

FIG. 1B also illustrates that the kill switch terminal 44 may include a terminal body 74 for carrying the emitter 45, the switch element 47, and an actuator (shown in one implementation as a button 75) that is coupled to element 47 to slidably open and close it (e.g., creating a short circuit condition between nodes N₁, N₂ when the switch element is closed). Of course, a sliding actuator/button is merely an example as well—e.g., other actuators exist (such as a rocker button, a momentary button, a non-momentary button, and a dial, just to name a few examples). FIGS. 1A and 1B further show that at least in some implementations, the switch terminal 44 may be carried by components of the device 8 other than the engine 9.

As shown in FIG. 3, the power/data connection 53 can be electrically connected to pin 3 of the microprocessor 46 via resistor 58. Pin 4 acts as a ground reference for the microcontroller 46, is in electrical communication with ground connection 55, and can be electrically grounded to the device's housing, structure, etc., as is known in the art.

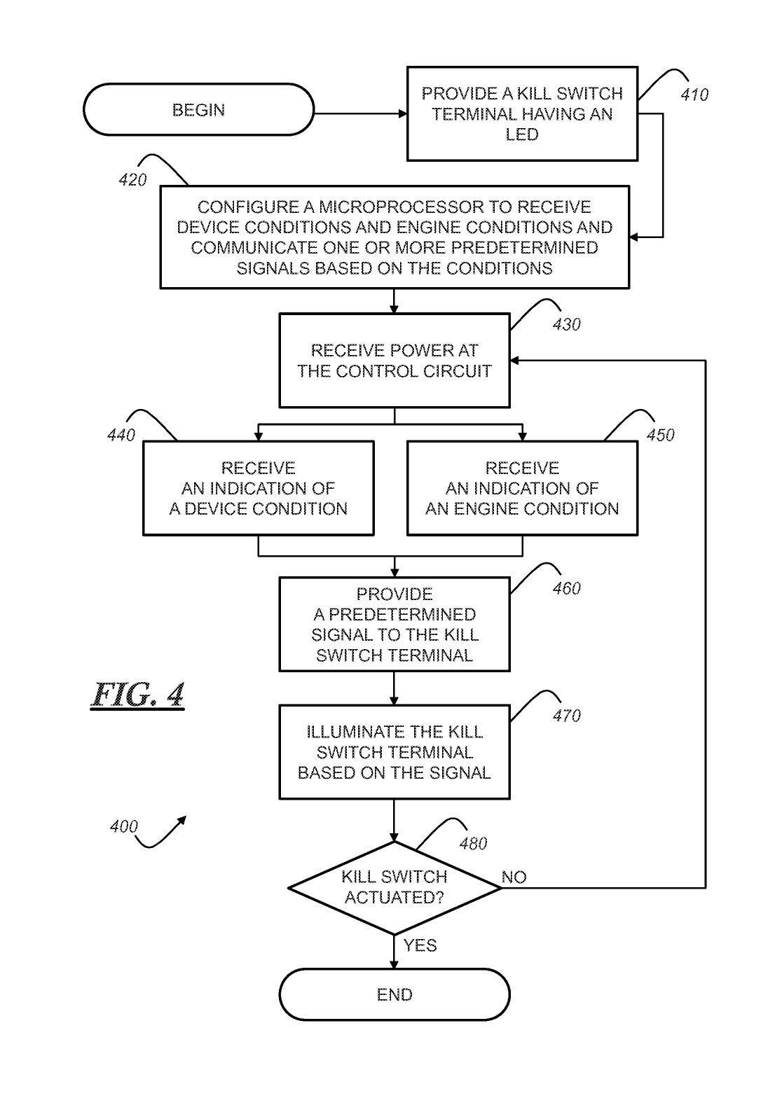

Now turning to FIG. 4, a method 400 is shown of providing control data using the control circuit 40 and kill switch terminal 44. It should be appreciated that the illustrated method is merely an example and that the components described below also are examples; other steps and similarly suited components also may exist. At step 410 the method begins by providing the kill switch terminal 44 shown in FIGS. 1A and 1B; the switch terminal 44 is electronically configured with a circuit arrangement as shown in FIG. 3.

Step 420 may occur before, after, or simultaneously to step 410. In step 420, the microprocessor 46 described above is configured to send and receive data. This step may occur at a manufacturing facility, service facility, or other suitable location during the assembly, calibration, or set-up of device 8 and/or engine 9. The configuration of the microprocessor 46 may include configuring the microprocessor to receive and interpret device data, engine data, or both—e.g., indicative of device and engine conditions (respectively). The microprocessor may be configured to receive device and/or engine data via pins 5, 7, or both and send control data, as described below, via pin 3.

The configuration step 420 further may include predetermining and pre-configuring one or more electrical signals representative of control data or control codes based on or associated with the device and/or engine conditions and storing these signals/codes in memory 51. As will be explained in greater detail below, these electrical signals will be transmitted to the kill switch terminal 44 (via pin 3) and may be converted to one or more messages using the emitter 45. In this implementation, the one or more messages may be visible; however, audible and/or tactile messages also are possible. According to one embodiment, the messages may include a variety of control codes.

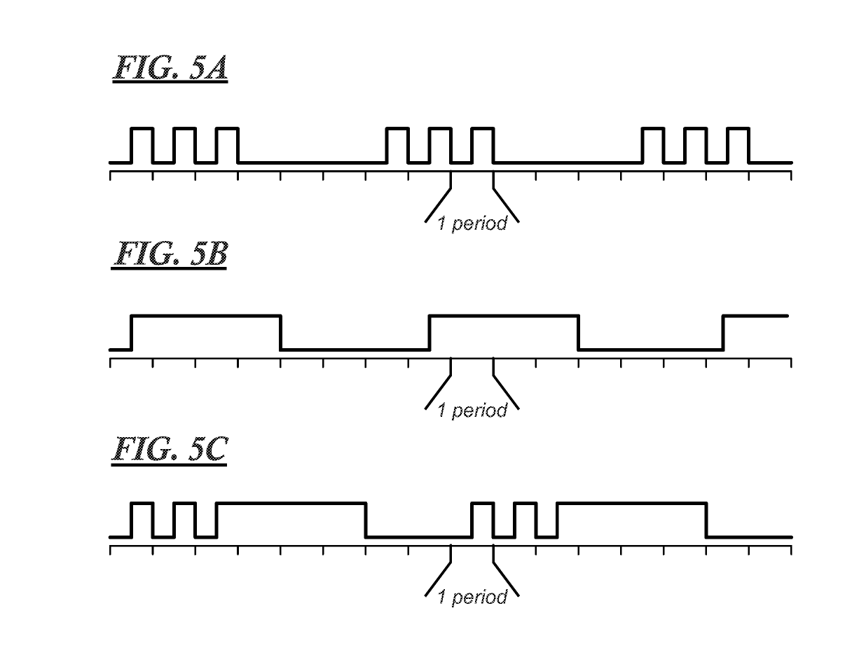

Examples of electrical signals that may be sent from the microprocessor 46 are shown in FIGS. 5A, 5B, and 5C. FIG. 5A illustrates a series of cycles or periods in which the signal goes both high and low, followed by one or more consecutive low periods. Thereafter, this pattern is repeated. A high signal may be representative of a 5V signal which may actuate the emitter 45 (e.g., illuminate the LED therein; or in other implementations, vibrate a tactile emitter or resonate audio from an audible emitter). A low signal may be representative of a 0V signal which may merely be the absence of the emission during a high signal (e.g., no illumination, no audio, no vibration, etc.).

FIG. 5B illustrates another pattern—a period going from low to high followed by one or more periods remaining high, followed by a period going from high to low, and finally followed by one or more low periods; this pattern thereafter repeats.

And FIG. 5C illustrates yet another example pattern—one or more periods in which the signal goes both high and low, followed by one or more consecutive high periods after which the signal goes low for one or more periods—this pattern thereafter repeats as well. The period length in each of the preceding examples may be of any suitable duration. Also, the electrical signal patterns may not repeat in some instances. Each of these patterns may be associated with or correspond to device or engine data and/or conditions. Again, these are merely examples; other examples will be apparent to skilled artisans.

The method 400 may proceed to step 430, after steps 410 and 420, wherein electrical power is received at the control circuit 40. As will be appreciated by skilled artisans, power may be received when the switch element 47 in the switch terminal 44 is in an open state (note: in a closed state, the control circuit 40 is not powered, as is the nature of kill switching). Step 430 may include starting the light-duty engine previously described; thus, it may include receiving operator input via the flywheel 12 (e.g., via the recoil rope starter). Thus, step 430 may occur anytime during an operative or ON mode of the light-duty engine. The circuit 40 may be powered by a battery. Or as described above, in at least one embodiment, the control circuit 40 may by powered using the CDI system 10. Following step 430, the method may proceed to step 440 or step 450.

In step 440, an indication of a device condition is received; and/or in step 450, an indication of an engine condition is received. These indication(s) may be received by the microprocessor 46 (e.g., received via pins 5, 7, or both). Steps 440 and 450 may include the microprocessor interpreting or deciphering the device or engine indications. Only one of steps 440 and 450 may occur or both steps may occur—and when both occur, they may occur sequentially or simultaneously.

Following step 440, 450, or both, the method proceeds to step 460 wherein a predetermined electrical signal is provided to the kill switch terminal 44. The predetermined signal may be one or more of the signals preconfigured in step 420. The providing step 460 includes communicating or transmitting the predetermined signal from pin 3 to power/data connection 53 (e.g., via the circuit path that includes resistor 58). Step 470 follows step 460.

In step 470, the predetermined signal provided by the microprocessor 46 powers the emitter 45 thereby illuminating the illustrated LED for a duration or in a pattern determined by the signal provided. Data is also displayed or communicated to the engine operator by the emission of the emitter 45 (e.g., via a blinking or flashing pattern)—as the emitter's output is controlled based on the provided predetermined signal (e.g., see patterns illustrated in FIGS. 5A-5C or any other suitable pattern). Thus, in step 470 the LED 45 is illuminated in a predetermined pattern providing the operator with a control code—e.g., illuminated when the electrical signal is high and not illuminated when the electrical signal is low. When it is desirable to not provide the operator a control code, the emitter 45 may be OFF or not be powered (all low); alternatively, the same message (i.e., no control code) may be communicated or conveyed by the emitter being constantly ON (all high). Thus, emitter ON or emitter OFF may be considered additional electrical signal patterns.

Following step 470, it may be determined at step 480 whether the kill switch terminal 44 is actuated—e.g., whether switch element 47 is open or closed. If the switch element is closed, the method ends as the engine power terminates, consequently killing or terminating the power to the microprocessor 46 and the remainder of the control circuit 40. However, if switch element 47 remains open, then the method may continue by repeating steps 430, 440, 450, 460, 470, and/or 480, as previously described.

It should be appreciated that the method 400 and other embodiments thereof may be carried out using a computer program product that includes a non-transitory, computer readable medium such as memory 51. As previously discussed, one or more applications may be stored thereon and executed by a processing device such as microprocessor 46. Execution of the application may cause the system to perform the method(s) using any suitable, stored method-related data. Computer programs can exist as software program(s) comprised of program instructions in source code, object code, executable code or other formats; firmware program(s); or hardware description language (HDL) files. Thus, it should be appreciated that the microprocessor 46 may: receive an indication that the small engine is powered; receive indications of device and/or engine conditions (and other associated data); determine or otherwise identify the received indications; associate the received indications with preconfigured and/or predetermined (and stored) electrical signals for transmission to the kill switch terminal's emitter 45; and, among other things, transmit the electrical signals that correspond with the received indication.

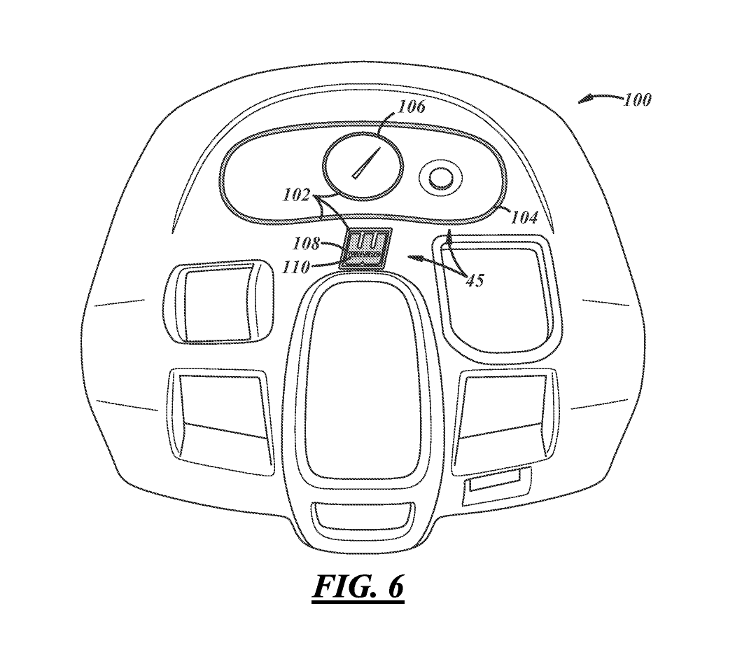

Other emitter embodiments exist as well. For example, while the kill switch terminal 44 may include the emitter 45, it will be appreciated that other parts or components associated with the light duty engine also may include one or more emitters 45. For example, FIG. 6 illustrates a cover or instrument cluster panel 100 of a riding lawnmower having multiple illumination members 102 which may be illuminated by one or more emitters 45 (emitters 45 can be hidden within or behind the cover 100 and/or within or behind the illumination members 102). The lawnmower cover 100 is merely an example; e.g., other covers, instrument panels, housings, etc. also may be used which may be associated with other types of light duty engines.

In FIG. 6, the illustrated illumination members 102 may include a light guide which highlights, accents, or at least partially encloses a portion of an instrument panel 104, a light guide which at least partially encloses an instrument gauge 106, and a backlit member 108. The light guide may be any suitable optical waveguide, such as an acrylic light pipe which is shaped to receive light from emitter 45 and project light outwardly from the cover 100. For example, the light guides of the instrument panel 104 and instrument gauge 106 may have an end coupled to at least one emitter 45 (e.g., an LED) and be configured to transmit light outwardly along the longitudinal lengths of the light guides. Backlit member 108 may include a translucent face 110 carried by the cover 100 which may or may not be embossed with a company emblem or logo. In FIG. 6, a logo is shown comprising the letters “W” and “Walbro,” however, this is merely an example; other logos or emblems also could be used.

Each of these illumination members 102 may or may not be used in combination with the kill switch terminal 44 described above. In one embodiment, at least one of the emitters 45 associated with illumination member(s) 102 may be used with the emitter 45 of kill switch terminal 44 (e.g., being electrically coupled in parallel with N₁ and N₂, as shown in FIG. 3). Thus for example, illumination members 102 could actuate ON and OFF according to the predetermined electrical signals or patterns discussed above. Thus, while emitter 45 (of kill switch terminal 44) is ON, the emitter(s) associated with one or more illumination members 102 may be ON as well. Likewise, when emitter 45 (of kill switch terminal 44) is OFF, the emitter(s) associated with the one or more illumination members 102 may be OFF as well. Therefore, in some instances, illuminating ON and OFF the illumination member(s) 102 may communicate device and/or engine data or conditions to the user of the small engine, as discussed above with respect to the emitter 45 of the kill switch terminal 44. And in other instances, illuminating the illumination members 102 ON and/or OFF may be merely for aesthetic or other reasons.

It should be appreciated that the emitters 45 associated with the cover 100 shown in FIG. 6 are merely examples and other embodiments exist. For example, cover 100 may include emitters 45 without illumination members 102. Or for example, illumination members 102 could be located in places other than cover 100 such as integrated into a carburetor (e.g., at or near a prime/purge bulb), integrated into a fuel tank (e.g., at or near a fuel pump or fuel cap), integrated into a handle, throttle switch or lever, air filter cover, or integrated into other components related to small engines, just to provide a few examples. And as discussed above, depending on the configuration, these illumination members may or may not communicate device and/or engine data or conditions to the user, as the kill switch terminal may be configured.

Thus, there has been described a control system that uses a control circuit and a kill switch terminal to provide an operator of a small engine device control data (which in at least some implementations includes diagnostic data). The provided data may be in the form of a control code audibly, tactilely, or visibly communicated using an emitter carried by the switch terminal. The switch terminal may have dual-functionality—e.g., during engine operation, it may be used to communicate control data; however, the same switch terminal may be used to shut down engine power at a later time.

While the forms of the invention herein disclosed constitute presently preferred embodiments, many others are possible. For example, the flow directing features can have other shapes, orientations, locations and functions as would be appreciated by persons of ordinary skill in this art in view of this disclosure. It is not intended herein to mention all the possible equivalent forms or ramifications of the invention. It is understood that the terms used herein are merely descriptive, rather than limiting, and that various changes may be made without departing from the spirit or scope of the invention.

1. A control system for a small engine operated device, comprising:
an emitter carried by the engine or a portion of the device spaced from the engine; and
a control circuit having memory with which control data related to device conditions, engine conditions or both is stored, and a processor in electrical communication with the first emitter, wherein the control circuit provides a signal corresponding to the control data to the emitter so that the emitter provides an output in response to device conditions, engine conditions, or both.

2. The control system of claim 1, wherein the first emitter provides at least one of an audible, tactile, or visible output recognizable to a user.

3. The control system of claim 2, wherein the first emitter is a light-emitting diode (LED).

4. The control system of claim 1, wherein the device includes a switch having at least two states, the emitter is associated with the switch, and the memory includes an application executable by the processor, and the application includes the following steps:
receiving an indication of an engine condition or a device condition; and
providing a predetermined electrical signal to the first emitter that corresponds to the indication while the switch is in at least one of said states.

5. The control system of claim 1, further comprising an illumination member illuminated by a second emitter.

6. The control system of claim 5, wherein the second emitter is electrically coupled to the first emitter, wherein the processor also provides a signal corresponding to control data to the second emitter in response to device conditions, engine conditions, or both received by the processor.

7. A control system for a small engine and small-engine device, comprising:
a kill switch terminal having a first emitter and a switch element, the switch element being configured for manual operation between at least two positions; and
a control circuit comprising:
memory that includes a non-transitory computer readable medium; and
a processor in electrical communication with the first emitter,
wherein the memory includes an application executable by the processor to provide a signal corresponding to control data to the first emitter in response to device conditions, engine conditions, or both received by the processor.

8. The control system of claim 7, wherein the first emitter provides at least one of an audible, tactile, or visible output recognizable to a user.

9. The control system of claim 8, wherein the first emitter is a light-emitting diode (LED).

10. The control system of claim 7, wherein the application includes the following steps:
receiving an indication of an engine condition or a device condition; and
providing a predetermined electrical signal to the first emitter that corresponds to the indication while the switch is in at least one of said positions.

11. The control system of claim 7, further comprising an illumination member illuminated by a second emitter.

12. The control system of claim 11, wherein the second emitter is electrically coupled to the first emitter, wherein the processor also provides a signal corresponding to control data to the second emitter in response to device conditions, engine conditions, or both received by the processor.

13. A method of providing control data to an operator of a small engine device, comprising the steps of:
powering a processor during small engine operation;
receiving an indication of an engine condition or a device condition at the processor; and
communicating to at least one emitter a control signal corresponding to the received indication.

14. The method of claim 13, wherein the control signal includes a predetermined pattern associated with a control message.

15. The method of claim 13 wherein the emitter provides a visual indication corresponding to the received indication.

16. The method of claim 15 wherein the visual indication includes emitted light.
